(19) United States
(12) Patent Application Publication
(10) Pub. No.: US 2021/0010530 A1
(43) Pub. Date: Jan. 14, 2021

(54) VARIABLE-LENGTH CONNECTING ROD HAVING AN INDEXING DEVICE

(71) Applicant: MCE 5 Development, Villeurbanne (FR)

(72) Inventor: Renè-Pierre Bertheau, Montagny (FR)

(21) Appl. No.: 16/616,883

(22) PCT Filed: May 25, 2018
(86) PCT No.: PCT/FR2018/051234

§ 371 Date: Nov. 25, 2019

(30) Foreign Application Priority Data
May 29, 2017 (FR) 17/54681

(51) Int. Cl. F16C 7/06; F02B 75/04

(52) U.S. Cl. CPC F16C 7/06; F02B 75/045; F16C 2226/62; F16C 2360/22; F16C 2233/00; F16C 2226/60

(57) ABSTRACT

A connecting rod for an internal combustion engine includes a first portion and a second portion respectively associated with a head and a foot. The portions are configured to slide relative to each other along the longitudinal axis of the connecting rod so as to form a variable-length connecting rod. The connecting rod comprises an indexing device of the first and second portions to ensure both of the portions are given a specific relative orientation. The indexing device comprises a first element, which is rigidly connected to the first portion and supported by the head of the connecting rod.

### CROSS-REFERENCE TO RELATED APPLICATIONS

This application is a national phase entry under 35 U.S.C. § 371 of International Patent Application PCT/FR2018/051234, filed May 25, 2018, designating the United States of America and published as International Patent Publication WO 2018/220318 A1 on Dec. 6, 2018, which claims the benefit under Article 8 of the Patent Cooperation Treaty to French Patent Application Serial No. 17/54681, filed May 29, 2017.

### TECHNICAL FIELD

The present disclosure relates to a connecting rod for an internal combustion engine. More precisely, the present disclosure relates to a variable-length connecting rod with an indexing device.

### BACKGROUND

Various solutions for adjusting the length of a connecting rod (i.e., the distance between the center distance between the head and the connecting rod at its foot) are known from the prior art. Such an adjustment can be ordered or carried out autonomously, for example, to modify the compression ratio of the engine, and place it in the most economical operating conditions depending on the load it deploys.

In some known solutions of variable-length connecting rods, for example, DE102015001066, the connecting rod consists of a first and a second portion, mechanically distinct from each other and associated respectively with the head of the connecting rod and the foot of the connecting rod. The two portions are assembled in such a way that they can slide relative to each other in the direction defined by the longitudinal axis of the connecting rod.

The connecting rod generally has a length adjustment mechanism, whether controlled or autonomous. This mechanism may thus include hydraulic and/or mechanical means (such as cylinders or springs), which make it possible to move the first portion and the second portion to a specific position relative to each other in the direction of the longitudinal axis of the connecting rod, and to give the connecting rod a specific length.

It is often necessary to block the longitudinal axis rotation movement from one portion to the other, in order to preserve parallelism or a precise angular offset between the axis of the connecting rod head and the axis of the connecting rod foot. For this purpose, the connecting rod can be equipped with an indexing device, i.e., a mechanism imposing a relative orientation between the two portions it consists of.

In addition, it may also be necessary to know the effective length of the connecting rod, for example, at a computer, to effectively control the engine. This is particularly the case when the adjustment of the connecting rod length is not controlled. This information can be used, for example, to determine the precise time, or the precise angular setting, at which the spark plug in the engine combustion chamber must be turned on.

Solutions using a contactless position sensor are known, the sensor being fixedly placed on the crankcase and identifying the proximity of a target fixedly placed on one of the two portions of the connecting rod (usually the one associated with the bottom of the connecting rod) or on the combustion piston. It can be a Hall effect sensor, in which case the target includes a magnetic element or a metallic mass. The signal delivered by the sensor can be analyzed, and its maximum indicates the time at which the target is positioned as close as possible to the sensor. A digital model or pre-established tables can be used to determine the length of the connecting rod by combining, for example, the information provided by the sensor with the angular position of the crankshaft.

The space defined by the crankcase in which different moving parts (crankshaft, pistons, connecting rod, etc.) are in motion is particularly limited. The additional elements of a variable-length connecting rod that are placed in this volume (indexing device, target, sensor, etc.) must be precisely arranged and configured so as not to interfere with the operation of the engine, while ensuring high reliability and precision in their functions. It is also desirable to limit the number of elements supported by the connecting rod in order to limit its weight and size.

The present disclosure provides a solution to this difficulty.

### BRIEF SUMMARY

The object of the present disclosure is to propose a connecting rod for an internal combustion engine comprising a connecting rod head and a connecting rod foot and consisting of a first portion and a second portion associated respectively with the head and the foot of the connecting rod. The two portions are configured to slide relative to each other along the longitudinal axis of the connecting rod so as to form a variable length connecting rod. The connecting rod includes an indexing device for the first and second portions to give them a specific relative orientation. According to the present disclosure, the indexing device includes a first element fixed to the first portion and supported by the head of the connecting rod.

According to other advantageous and unrestrictive characteristics of the present disclosure, taken alone or in any technically feasible combination:
the indexing device comprises a second element rigidly connected to the second portion, the first element and the second element cooperating to block the rotation movement of the longitudinal axis of one portion with respect to the other;
the second element is rigidly connected to the second portion through an extension;
the first element is a steering pin parallel to the longitudinal axis of the connecting rod and the second element is a part with a bore whose size corresponds to that of the pin;
the first portion comprises a cap assembled by a fixing screw, the first element corresponding to a projecting end of the fixing screw;
the second element carries a target that can be identified by a sensor to determine the effective length of the connecting rod;
the target comprises a magnet housed in a hollow body, the hollow body being fixed to the second element.

### BRIEF DESCRIPTION OF THE DRAWINGS

Other characteristics and advantages of the present disclosure will emerge from the detailed description of the present disclosure that follows with reference to the appended figures on which:

the FIGS. 1a and 1b, respectively, show in isometric perspective and in cross-section, a first exemplary connecting rod for an internal combustion engine according to the present disclosure;

FIGS. 2a and 2b show, respectively, in isometric perspective and in cross-section, a second exemplary connecting rod for an internal combustion engine according to the present disclosure.

### DETAILED DESCRIPTION

In order to simplify the following description, the same references are used for identical elements or elements performing the same functions in the various embodiments of the present disclosure.

FIGS. 1a and 1b represent an example of a connecting rod 1 for an internal combustion engine according to the present disclosure. It includes a head 2, a foot 3 and a body linking the head 2 and the foot 3. As is particularly visible in FIG. 1b, the connecting rod 1 consists of two portions 5a, 5b respectively associated with the head 2 and the foot 3 of the connecting rod 1. The two portions 5a, 5b are capable of sliding relative to each other along the longitudinal axis of the connecting rod 1, when assembled to form a variable length connecting rod.

The connecting rod 1, the first portion 5a and/or the second portion 5b may include other elements, such as hydraulic and/or mechanical means forming in combination a mechanism for adjusting the length of the connecting rod 1. Thus, in the example shown in FIGS. 1a and 1b, the connecting rod 1 includes a spring 6, a hydraulic piston 7 and a hydraulic cylinder 8. But the present disclosure is by no means limited to a connecting rod comprising such a length adjustment mechanism, and other configurations can be considered to form a variable length connecting rod while remaining within the scope of the present disclosure.

In addition to the functional sliding movement, the two portions 5a, 5b of the connecting rod 1 can be oriented relative to each other by longitudinal axis rotation. In order to prevent this movement and to give a specific relative orientation between the first portion 5a and the second portion 5b, the connecting rod 1 is equipped with an indexing device 9.

According to the present disclosure, the indexing device 9 includes an element 9a supported by the head 2 of the connecting rod and therefore fixed to the first portion 5a.

The indexing device 9 also includes a second element 9b attached to the second portion 5b.

When the two portions 5a, 5b of the connecting rod 1 are assembled together, the first element 9a and the second element 9b cooperate to block the longitudinal axis rotation movement of one portion 5a, 5b with respect to the other. The connection formed between the two elements 9a, 9b blocks the rotational movement, within the operating clearance, and therefore imposes a determined relative orientation between the first portion 5a and the second portion 5b of the connecting rod 1.

By having the indexing device 9 supported by the head 2 of the connecting rod 1, it is possible to position this device 9 at a significant distance from the central axis of the body of the connecting rod 1, more important than if this device were supported, for example, by the body of the connecting rod itself. Consequently, the operating clearances between the first element 9a and the second element 9b of the indexing device 9 result in a low angular displacement, and therefore a better dynamic positioning of the two portions 5a, 5b of the connecting rod 1.

Advantageously, to ensure this better positioning, the first element 9a is positioned on the head of the connecting rod at a distance from the longitudinal axis greater than one-third of the distance separating this axis from an outer flank of the head 2 of the connecting rod 1.

For example, and as shown in FIGS. 1a and 1b, the first element 9a may be a pin attached to the head 2 of the connecting rod 1, the longitudinal axis of the pin being parallel to the longitudinal axis of the connecting rod 1. The second element 9b of the indexing device 9 is in this case a part with a bore whose dimensions correspond to those of the pin 9a to allow it to slide and form the slide link. Of course, an inverse indexing device 9 could be used, i.e., the pin could be supported by the second portion 5b of the connecting rod 1 and the part with the bore could be supported by the first portion 5a. In addition, any other combination of elements 9a, 9b allowing a slide link to be made is possible, for example, a part with a groove cooperating with another part with a stud. The present disclosure is naturally by no means limited to a combination of particular parts.

To place the second element 9b opposite the first element 9a, and form the slide link, the second element 9b can be connected to the second portion 5b by at least one extension 10. During the engine operation, the indexing device 9 also has the advantage of blocking any vibration modes that may form in this extension 10. It is therefore not necessary to make it particularly rigid, and this avoids adding unnecessary weight to the connecting rod.

Thus, as shown in FIGS. 1a and 1b, the extension 10 can be formed by one or a plurality of tapered rod(s), the shape of which has been configured to allow one end to be fixed to the second portion 5b of the connecting rod 1, and to ensure the positioning of the other end, which supports the second element 9b, opposite the first element 9a.

In a particularly ingenious way, the second element 9b can also support a target 11, which can be identified by a sensor, in order to determine the effective length of the connecting rod 1. When the sensor is a Hall effect sensor, this target may include a magnet or a metal mass, optionally housed in a hollow body, for example, made of aluminum. The hollow body is fixed on the second element 9b and allows the target to be held. In its absence, the target can be directly fixed on the second element 9b.

A single device 9, supported by the head 2 of the connecting rod, is then available, allowing both the indexation of the two portions 5a, 5b of the connecting rod 1 and the support of the marking target 11. This allows a particularly compact connecting rod to be formed and reduces the size of the engine. The target is also positioned near the head 2 of the connecting rod 1, which is located in the crankcase under the bottom of the cylinder, accessible for mounting the sensor.

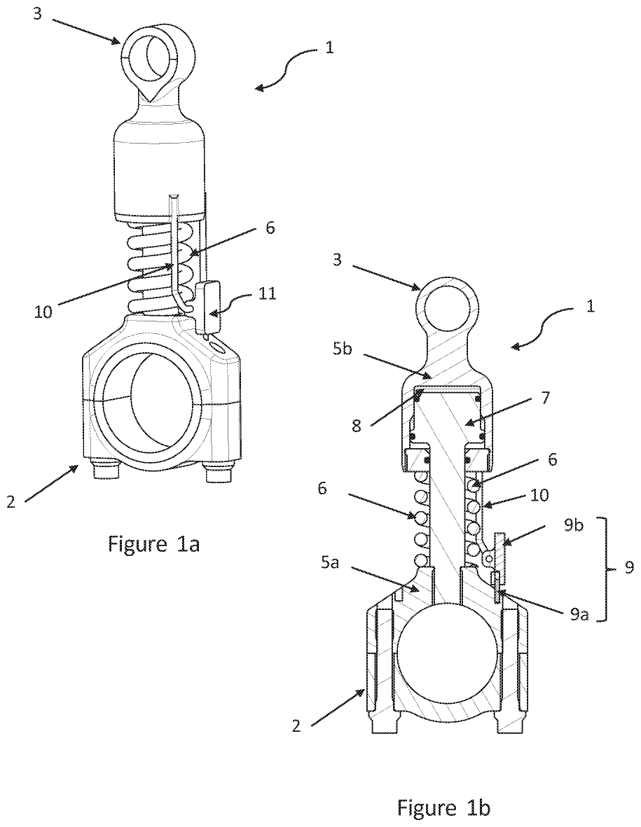

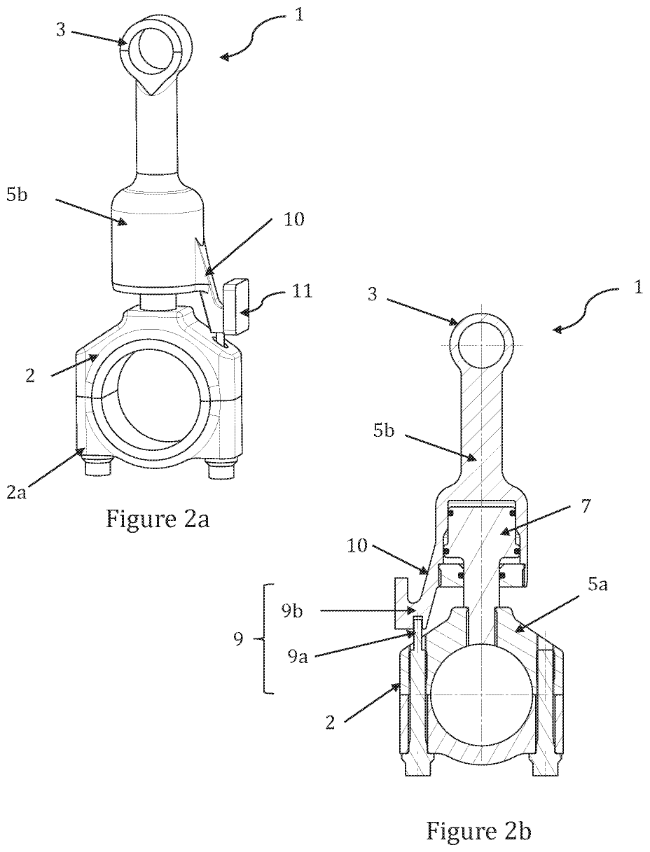

FIGS. 2a and 3b show a second exemplary embodiment of a connecting rod 1 according to the present disclosure. In this second example, the hydromechanical elements of the connecting rod length adjustment device are integrated into the piston 7. The second portion 5b includes a skirt defining a housing in which this mechanism is placed. The end of the skirt is close to the head of the connecting rod 1.

In this example, the head 2 of the connecting rod 1 includes a cap 2a held by at least one screw for fixing the connecting rod cap. The screw body (or stud) has a preferably unthreaded end. And it is of sufficient length so that, when assembled to the head 2 to hold the cap 2a, the protruding unthreaded end forms the pin 9a of the indexing device 9. In this way, the pin 9a on the first portion 5a of the connecting rod 1 is particularly easily formed. This also ensures that this pin 9a is positioned at a sufficient distance from the longitudinal axis of the connecting rod to limit the angular deflection of the portions 5a, 5b relative to each other.

Note that this configuration is by no means limited to the connecting rod of this second example. For example, it can be fully applied to the connecting rod of the preceding example, shown in the FIGS. 1a, 1b.

Continuing the description of the connecting rod 1 shown in FIGS. 2a and 2b, the second element 9b of the indexing device 9 consists of a body with a bore cooperating with the pin 9a. The body 9b is connected to the second portion 5b of the connecting rod 1, and more precisely at the bottom of the skirt, by an extension 10, which takes the form of a rigid arm. As in the preceding example, the second element 9b advantageously supports the target 11.

Of course, the present disclosure is not limited to the embodiments described and alternative embodiments can be provided within the scope of the present disclosure as defined by the claims.

4. The connecting rod of claim 3, wherein the first element is a steering pin oriented parallel to the longitudinal axis of the connecting rod and the second element is a part having a bore, the bore having a size corresponding to a size of the pin.

5. The connecting rod of claim 4, wherein the first portion comprises a cap assembled by a fixing screw, the first element comprising a projecting end of the fixing screw.

6. The connecting rod of claim 5, wherein the second element supports a target capable of being detected by a sensor, in order to determine an effective length of the connecting rod.

7. The connecting rod of claim 6, wherein the target comprises a magnet housed in a hollow body, the hollow body being fixed to the second element.

8. The connecting rod of claim 2, wherein the first element is a steering pin oriented parallel to the longitudinal axis of the connecting rod and the second element is a part having a bore, the bore having a size corresponding to a size of the pin.

9. The connecting rod of claim 2, wherein the second element supports a target capable of being detected by a sensor, in order to determine an effective length of the connecting rod.

10. The connecting rod of claim 9, wherein the target comprises a magnet housed in a hollow body, the hollow body being fixed to the second element.

11. The connecting rod of claim 1, wherein the first portion comprises a cap assembled by a fixing screw, the first element comprising a projecting end of the fixing screw.
